(19) United States
(12) Patent Application Publication
(10) Pub. No.: US 2014/0072378 A1
(43) Pub. Date: Mar. 13, 2014

(54) MILLING CUTTER

(71) Applicants: HON HAI PRECISION INDUSTRY CO., LTD., New Taipei (TW); FU TAI HUA INDUSTRY (SHENZHEN) CO., LTD., Shenzhen (CN)

(72) Inventors: HAI-WANG ZHONG, Shenzhen (CN); GUANG-TAO LI, Shenzhen (CN); SHEN-CHANG YU, Shenzhen (CN); ZUO-PING WANG, Shenzhen (CN); LIAO-NING LUO, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/963,100

(22) Filed: Aug. 9, 2013

(30) Foreign Application Priority Data
Sep. 7, 2012 (CN) 2012103290115

(51) Int. Cl. B23C 5/10

(52) U.S. Cl. CPC B23C 5/10
USPC 407/54

(57) ABSTRACT

A combination milling bit and cutter employed to machine a distal end of a workpiece is provided, in which the milling cutter includes a handle and a cutting portion formed on an end of the handle. The cutting portion includes two cutting edges; at least one of the two cutting edges comprises one cutting sub-edge for milling the distal end of the workpiece to form an end surface, and another cutting sub-edge for chamfering the distal end of the workpiece at both an annular outer chamfering surface and an annular inner chamfering surface on the distal end. The combination milling and cutting cutter device carries out both milling and cutting actions in a single operation.

### BACKGROUND

1. Technical Field

The present disclosure relates to a cutter, and more particularly, to a milling cutter.

2. Description of Related Art

Referring to FIG. 1, a workpiece 100 produced by punching, which includes a base seat 10 and a rod portion 20 on the base seat 10. The rod portion 20 includes a distal end 201 away from the base seat 10 and defines an axial hole 203 on the distal end 201 thereof. Burrs may be formed on the distal end 201 in the punching process. A conventional milling process is employed to machine the distal end 201 to remove the burrs, thereby forming an annular end surface 2044, an annular outer chamfering surface 2013 and an annular inner chamfering surface 2015 on the distal end 201 of the rod portion 20. The annular outer chamfering surface 2013 connects with the annular inner chamfering surface 2015 via the annular end surface 2044. In detail, the milling steps of the conventional milling process are as follows: a flat-end milling cutter mills the distal end 201 to form the annular end surface 2044; an outer R cutter chamfers an outer periphery of the distal end 201 to form the annular outer chamfering surface 2013; and an inner R cutter chamfers an inner periphery of the distal end 201 to form the annular inner chamfering surface 2015. However, the milling process is time-consuming. In addition, the annular inner chamfering surface 2015 and the annular outer chamfering surface 2013 are produced or formed independently, segmental differences between the annular inner chamfering surface 2015, the annular end surface 2044, and the annular outer chamfering surface 2013 are easily created or formed, and a quality thereof is thereby reduced.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of a workpiece produced by a conventional milling process.

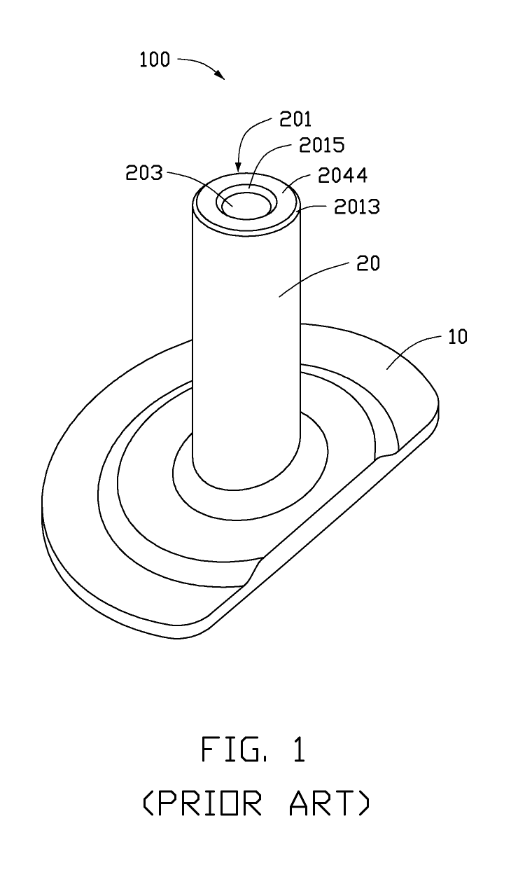

FIG. 2 is an isometric view of an embodiment of a milling cutter.

FIG. 3 is an enlarged view of a circled portion III of the milling cutter of FIG. 2.

FIG. 4 is an isometric view of the milling cutter of FIG. 2 shown in a state of use.

### DETAILED DESCRIPTION

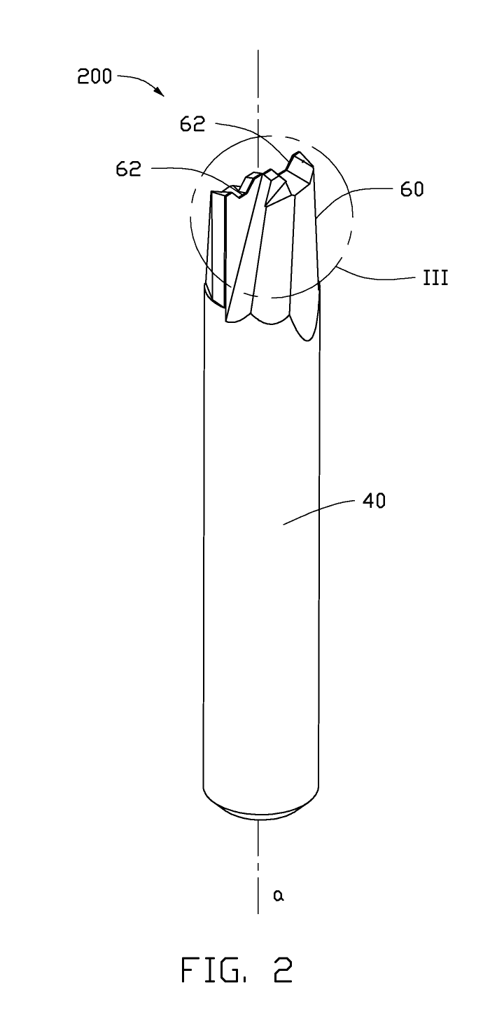

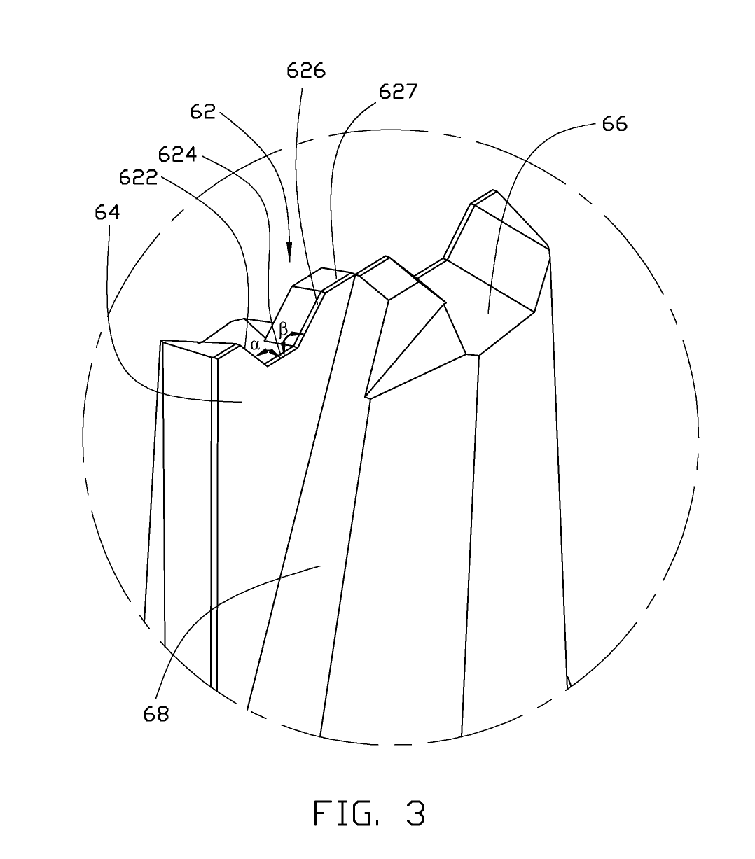

FIGS. 2 through 4 show an embodiment of a milling cutter 200 for milling a workpiece 300. The workpiece 300 produced includes a base seat 12 and a rod portion 22 on the base seat 12. The rod portion 22 includes a distal end 221 away from the base seat 12 and defines an axial hole 223 on the distal end 221. The milling cutter 200 mills the distal end 221 to remove the burrs, thereby forming an annular end surface 2244, an annular outer chamfering surface 2213 and an annular inner chamfering surface 2215 on the distal end 221 of the rod portion 22 of the workpiece 300. The annular outer chamfering surface 2213 connects with the annular inner chamfering surface 2215 via the annular end surface 2244.

The milling cutter 200 is substantially a rod shape, and includes a handle 40 and a cutting portion 60 on an end of the handle 40. The handle 40 is substantially a cylindrical shape, and a cross-sectional view taken perpendicular to a central axis a thereof shows substantially a circular shape. The handle 40 is fixed to a driving mechanism (not shown), such as a CNC machine. In the illustrated embodiment, the handle 40 extends along the central axis a, and rotates around the central axis a, thereby driving the cutting portion 60 to mill the workpiece 300. The cross-sectional view of the handle 40 taken perpendicular to the central axis may be a rectangular, triangular or other shape.

The cutting portion 60 of the milling cutter 200 includes a pair of cutting edges 62 arranged along a radial direction of the cutting portion 60. The two cutting edges 62 face each other and are offset from each other along the radial direction of the cutting portion 60. Each cutting edge 62 includes a first cutting sub-edge 622, a second cutting sub-edge 624, a third cutting sub-edge 626, connected in that order. The second cutting sub-edge 624 interconnects the first cutting sub-edge 622 and the third cutting sub-edge 626 and is depressed toward the handle 40. The first cutting sub-edge 622 is located adjacent to a periphery of the cutting portion 60, the third cutting sub-edge 626 is located adjacent to a center of the cutting portion 60, and the second cutting sub-edge 624 is perpendicular to the central axis a of the handle 40. The first cutting sub-edge 622 and the second cutting sub-edge 624 cooperatively define a first intersection angle α therebetween, and the third cutting sub-edge 626 and the second cutting sub-edge 624 cooperatively define a second intersection angle β therebetween. The first intersection angle α is an obtuse angle and is equal to the second intersection angle β. In other embodiments, the first intersection angle α may be not equal to the second intersection angle β. Each cutting edge 62 connects with the other cutting edge 62 via the third cutting edges 626. Each cutting edge 62 further defines a rack surface 64 at a front side thereof facing the other one cutting edge 62, a flank surface 66 away from the rack surface 64, and a chip removal surface 68 at a side of the third cutting sub-edge 626 away from the first cutting sub-edge 622. Front edges of the first cutting sub-edge 622, the second cutting sub-edge 624 and the third cutting sub-edge 626 are coplanar with the rack surface 64. The chip removal surface 68 is located at the front of the rack surface 64 of the other one cutting edge 62. A distance between the chip removal surface 68 and the first cutting sub-edge 622 increases along the central axis a toward the handle 40, and the chip removal surface 68 connects with a periphery of the handle 40. In the embodiment, each cutting edge 62 further includes a connecting edge 627 connected to an end of the third cutting sub-edge 626 away form the second cutting sub-edge 626. The two cutting edges 62 are connected to each other via the connected edges 627, and the chip removal surface 68 is located at a side of the connecting edge 627 away from the third cutting sub-edge 626.

In the embodiment, the number of the cutting edges 62 is two and the two cutting edges 62 are aligned in a straight line. The first cutting sub-edge 622, the second cutting sub-edge 624, and the third cutting sub-edge 626 are integrally formed with the handle 40, thereby obtaining a more compact structure. Thus, the milling cutter 200 is suitable for machining a small workpiece. The cutting portion 60 may include more (or extra) cutting edges 62 separately aligned along a radial direction of the cutting portion 60. The milling cutter 100 is made of suitable materials. Normally, the milling cutter 100 is made of hard alloy or high-speed steel (HSS) which have a higher hardness and better heat-dissipating properties. The pair of first cutting sub-edges 622 may be coated with a hard film layer to enhance a performance of the milling cutter 200. In view of the requirements of the milling cutter 200, the hard film(s) layer may be made of titanium carbide (TiC), aluminum titanium nitride (AlTiN), titanium aluminum nitride (TiAlN), or titanium carbon nitride (TiCN).

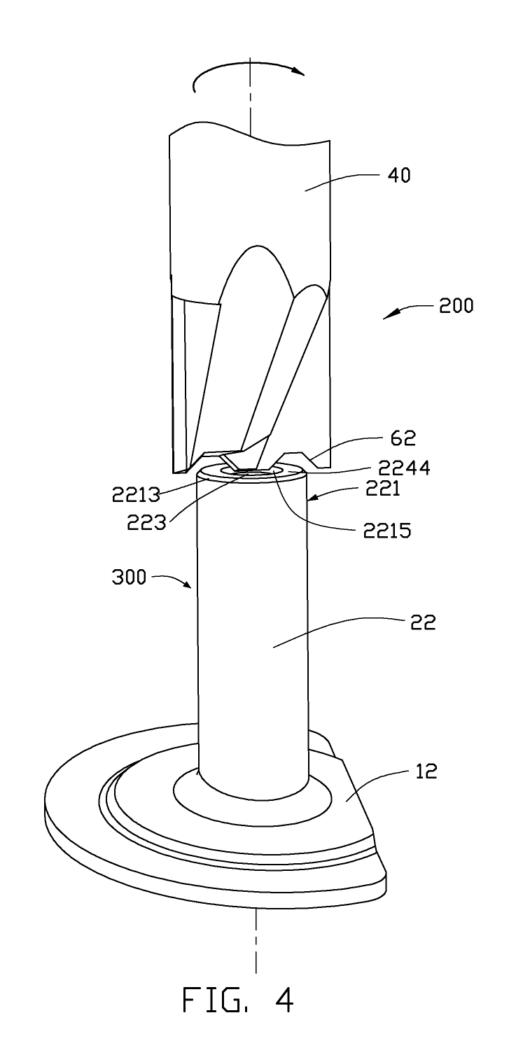

Also referring to FIG. 4, when in use, the milling cutter 200 is held by the driving mechanism of the CNC machine, the central axis a of the handle 40 is coaxial with an axial direction of the workpiece 300. The second cutting sub-edge 624 resists the annular end surface 2244 of the workpiece 300. The third cutting sub-edge 626 is partially received in the axial hole 223 and defines an angle with the inner surface of the workpiece 300. The first cutting sub-edge 622 and the outer surface of the workpiece 300 define an angle. The milling cutter 200 rotates clockwise around the central axis a to machine the distal end 221 of the workpiece 300, thereby forming the annular end surface 2244 (of finished shape and condition) by the second cutting sub-edge 626, the annular outer chamfering surface 2213 by the first cutting sub-edge 622, and the annular inner chamfering surface 2215 by the third cutting sub-edge 626. When the annular outer chamfering surface 2213 is not needed, the first cutting sub-edge 622 may be omitted. When the annular inner chamfering surface 2215 is not needed, the third cutting sub-edge 626 may be omitted.

The cutting edge 62 employs the first cutting sub-edge 622, the second cutting sub-edge 624 and the third cutting sub-edge 626 in that order to machine the workpiece 300, and forms the annular end surface 2244, the outer chamfering surface 2213, and the inner chamfering surface 2215 in one operation, which is a great time-saver. Segmental differences between the inner chamfering surface 2013, the end surface 2044, and the outer chamfering surface 2015 found in the workpiece 100 made by conventional milling process using various milling cutters are thereby sharply reduced as compared to the workpiece 300 of the embodiment. The milling cutter 200 may be employed to machine other portion of a workpiece, such as machining an end of a side wall of the workpiece.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A milling cutter employed to mill a distal end of a workpiece, comprising:
a handle; and
a cutting portion formed on an end of the handle, wherein the cutting portion comprises two cutting edges, at least one of the two cutting edges comprises a first cutting sub-edge for chamfering the distal end of the workpiece to form an annular outer surface, and a second cutting sub-edge for milling the distal end of the workpiece.

2. The milling cutter of claim 1, wherein the first cutting sub-edge is directly connected to the second cutting sub-edge, the first cutting sub-edge and the second cutting sub-edge cooperatively define an obtuse angle therebeween.

3. The milling cutter of claim 2, wherein the cutting edge further comprises a third cutting sub-edge, the second cutting sub-edge interconnects the first cutting sub-edge and the third cutting sub-edge, and is depressed toward the handle.

4. The milling cutter of claim 3, wherein the third cutting sub-edge and the second cutting sub-edge cooperatively define an obtuse angle therebeween, the first cutting sub-edge is located adjacent to a periphery of the cutting portion, the third cutting sub-edge is located adjacent to a center of the cutting portion.

5. The milling cutter of claim 4, wherein the two cutting edges face each other and are offset from each other along a radial direction of the cutting portion.

6. The milling cutter of claim 5, wherein the two cutting edges connect with each other by the two third cutting sub-edges, each cutting edge further defines a rack surface at a front side thereof facing the other one cutting edge, a flank surface away from the rack surface, and a chip removal surface at a side of the third cutting sub-edge away from the first cutting sub-edge.

7. The milling cutter of claim 6, wherein the first cutting sub-edge, the second cutting sub-edge and the third cutting sub-edge are coplanar with the rack surface, and the chip removal surface is located at the front of the rack surface of the other one cutting edge.

8. The milling cutter of claim 7, wherein a distance between the chip removal surface and the first cutting sub-edge increases along an axis direction toward the handle, and the chip removal surface connects with a periphery of the handle.

9. A milling cutter employed to mills a distal end of a workpiece, comprising:
a handle; and
a cutting portion formed on an end of the handle, wherein the cutting portion comprises two cutting edges arranged along a radial direction of the cutting portion, the two cutting edges face each other, each cutting edge comprises a first cutting sub-edge and a second cutting sub-edge connected to the first cutting sub-edge, the second cutting sub-edge mill the distal end to form an annular end surface, and the first cutting sub-edge chamfer the distal end of the workpiece.

10. The milling cutter of claim 9, wherein the first cutting sub-edge and the second cutting sub-edge cooperatively define an obtuse angle therebeween.

11. The milling cutter of claim 9, wherein each cutting edge further comprises a third cutting sub-edge, the second cutting sub-edge interconnects the first cutting sub-edge and the third cutting sub-edge and is depressed toward the handle.

12. The milling cutter of claim 11, wherein the third cutting sub-edge and the second cutting sub-edge cooperatively define an obtuse angle therebeween, the first cutting sub-edge is located adjacent to a periphery of the cutting portion, the third cutting sub-edge is located adjacent to a center of the cutting portion.

13. The milling cutter of claim 12, wherein the two cutting edges connects with each other by the two third cutting sub-edges, each cutting edge further defines a rack surface at a front side thereof facing the other one cutting edge, a flank surface away from the rack surface, and a chip removal surface at a side of the third cutting sub-edge away from the first cutting sub-edge.

14. The milling cutter of claim 13, wherein the first cutting sub-edge, the second cutting sub-edge and the third cutting sub-edge are coplanar with the rack surface, and the chip removal surface is located at the front of the rack surface of the other cutting edge.

15. The milling cutter of claim 14, wherein a distance between the chip removal surface and the first cutting sub-edge increases along an axis direction toward the handle, and the chip removal surface connects with a periphery of the handle.
